(19) United States
(12) Patent Application Publication
(10) Pub. No.: US 2014/0234821 A1
(43) Pub. Date: Aug. 21, 2014

(54) Simulator for simulation of surgical procedures, particularly in cardiac and thoracic surgery

(71) Applicant: Fehling Medical Corporation, Acworth, GA (US)

(72) Inventor: Ingo Kutschka, Hannover (DE)

(73) Assignee: Fehling Medical Corporation, Acworth, GA (US)

(21) Appl. No.: 14/179,734

(22) Filed: Feb. 13, 2014

(30) Foreign Application Priority Data
Feb. 15, 2013 (DE) 20 2013 100 701.3

(51) Int. Cl. G09B 23/28

(52) U.S. Cl. CPC G09B 23/28
USPC 434/262

(57) ABSTRACT

A simulator for surgical procedures is disclosed. The simulator can include a frame having a first wall and a second wall, where a passage opening is disposed in the first wall. Additionally, a variable wall can be inserted on the second wall in at least two different positions and the variable wall can have an opening.

### CROSS REFERENCE TO RELATED APPLICATIONS

This application claims priority to German Patent Application No. DE 20 2013 100 701.3 filed Feb. 15, 2013, which is hereby incorporated by reference in its entirety.

### DESCRIPTION

This application relates to a simulator for simulation of surgical procedures, particularly in cardiac and thoracic surgery.

For training and continuing education of surgeons, it is necessary to simulate complex procedures and to train on simulators.

One task consists of making available a cost-advantageous simulator for simulation of surgical procedures, particularly minimally invasive and video-assisted procedures, particularly in cardiac and thoracic surgery.

This task is accomplished, by means of a simulator for simulation of surgical procedures, particularly in cardiac and thoracic surgery, having the features and structures disclosed herein.

The simulator for simulation of surgical procedures, particularly in cardiac and thoracic surgery, has a frame having a first wall and a second wall, wherein a passage opening is disposed in the first wall, wherein a variable wall can be inserted on the second wall in at least two different positions, and wherein the variable wall has at least one opening. In this connection, the first wall and the second wall are particularly disposed at an angle to one another, particularly at a right angle. The frame simulates the chest of the patient; the passage opening simulates the access to the chest of the patient. The instruments required for the surgical procedure are introduced into the housing through the passage opening, with the surgeon operating the instruments outside of the housing. Different difficulties can be simulated by means of the variable wall, which can be disposed in different positions relative to the first wall, because the distance between the variable wall, on which a surgical procedure is to be performed, and the passage opening is therefore variable. The opening in the variable wall allows accommodation of an artificial body part on which a surgical procedure is to be performed.

An advantageous further development of the disclosure provides that at least two variable walls can be disposed on the second wall, so that different artificial body parts can be disposed relative to one another.

A particularly preferred embodiment of the disclosure provides that the frame is part of a housing having a bottom part and a lid part, wherein the bottom part has the first wall, the second wall, and three further walls. The lid part allows a view into the housing when the lid is open, and therefore into the chest, in order to be able to see directly what activities are being performed. When the housing is closed, a minimally invasive procedure with video camera support can be practiced.

According to a particularly simple design embodiment of the simulator, it is provided that the variable wall can be inserted into grooves that are disposed in or on the walls. This allows particularly simple and stable attachment of the variable wall in the frame or housing.

In an alternative, an artificial body part can be inserted directly into the opening in the variable wall. Depending on the type of artificial body part, however, it is preferred if an attachment apparatus for an artificial body part is disposed on the variable wall.

The holding apparatus and/or attachment apparatus can preferably be configured as a plate that can be attached to the variable wall, particularly with screws, which plate has an opening, in order to be able to clamp artificial body parts in place between the variable wall and the plate.

Preferably, the variable wall has two openings, into which artificial body parts, for example in the form of cylindrical foam elements or rubber elements or in the form of rolled foam elements or rubber elements, can be inserted.

A particularly preferred embodiment of the disclosure provides that a setup element, for example a setup flap, a setup bracket or a setup foot is disposed on the frame of the housing, in order to be able to tilt the frame or housing and to facilitate access through the passage opening.

A preferred embodiment of the disclosure provides that the simulator has a camera and a light source, in order to be able to observe the surgical activities in accordance with a minimally invasive procedure, by way of the video camera, when the housing is closed or when the frame is covered with a cover plate or a cloth cover.

The simulator preferably has at least one hollow tube, particularly preferably multiple hollow tubes having different lengths, for insertion into the passage opening. In this way, different thicknesses of the chest wall can be simulated, and thereby the difficulty of the simulation can be increased, step by step, because the movement possibilities of the surgical instruments are increasingly restricted with an increasing length of the hollow tube.

It is advantageous if the simulator has a plastic cuff, for example a silicone cuff, for insertion into the passage opening. This cuff particularly forms a soft contact edge. Furthermore, it is possible to attach suture material to the plastic cuff during the simulation.

The simulator preferably comprises at least one artificial body part and/or a template for the production of an artificial body part for insertion into the opening of the variable wall. The artificial body part can be, for example, a piece of cloth, for example a microfiber cloth, which can simulate a heart valve, or a foam rubber part, for example in the form of a cylinder or a rectangular element that can be rolled up to form a cylinder, which can simulate a heart muscle. The templates merely represent the outline of the artificial body part and can be transferred to a piece of cloth, for example a microfiber cloth, a foam rubber part, or the like, in order to subsequently produce the artificial body part accordingly, particularly to cut it out.

In a preferred embodiment, an edge, particularly the upper edge of the variable wall, has recesses into which surgical instruments can be laid. In this way, it is made possible to stow the surgical instruments required for the simulation in the housing, and also to transport them without damage.

Preferably, the frame or the housing and the variable walls are made of wood or plastic or metal, for example aluminum, which allows particularly simple and cost-advantageous production.

The disclosure will be explained in detail below, using the following figures. These show:

### BRIEF DESCRIPTION OF THE DRAWINGS

FIG. 1 is a front view of a housing of a first exemplary embodiment of a simulator according to the disclosure.

FIG. 2 is a longitudinal section through the housing according to FIG. 1,

FIG. 3 is a top view of the bottom part of the housing according to FIG. 1,

FIG. 4 a top view of a grooved plate of the housing according to FIG. 1,

FIG. 5 is a top view of a first exemplary embodiment of a variable wall of the housing according to FIG. 1,

FIG. 6 is a top view of a reinforcement plate for the variable wall according to FIG. 5,

FIG. 7 is a side view of a hollow tube,

FIG. 8 is a top view of the hollow tube according to FIG. 7,

FIG. 9 is a top view of a further exemplary embodiment of a variable wall of the housing according to FIG. 1,

FIG. 10 is a view from above of the variable wall according to FIG. 9,

FIG. 11 is a top view of a reinforcement plate for the passage opening of the housing according to FIG. 1,

FIG. 12 is a holding apparatus and/or attachment apparatus for the variable wall according to FIG. 9,

FIG. 13 is a top view of a further exemplary embodiment of a variable wall,

FIG. 14 is a top view of an exemplary embodiment of a template for production of an artificial body part,

FIG. 15 is a top view of a further exemplary embodiment of a template for production of an artificial body part,

FIG. 16 is the housing according to FIG. 1 with a folded-open setup flap,

FIG. 17 is the housing according to FIG. 16 in a front view,

FIG. 18 is a side view of the setup flap of the housing according to FIG. 16,

FIG. 18a is a top view of the setup flap according to FIG. 18,

FIG. 19 is a section through a second exemplary embodiment of a simulator according to the disclosure,

FIG. 20 is a top view of the second wall of the simulator according to FIG. 19,

FIG. 21 is a front view of the simulator according to FIG. 19,

FIG. 22 is a top view of an exemplary embodiment of a variable wall,

FIG. 23 is a side view of the variable wall according to FIG. 22,

FIG. 24 is a top view of the holding apparatus and/or attachment apparatus or the variable wall according to FIG. 22, and

FIG. 25 is a top view of a further exemplary embodiment of a variable wall.

### DETAILED DESCRIPTION OF THE ILLUSTRATED EMBODIMENTS

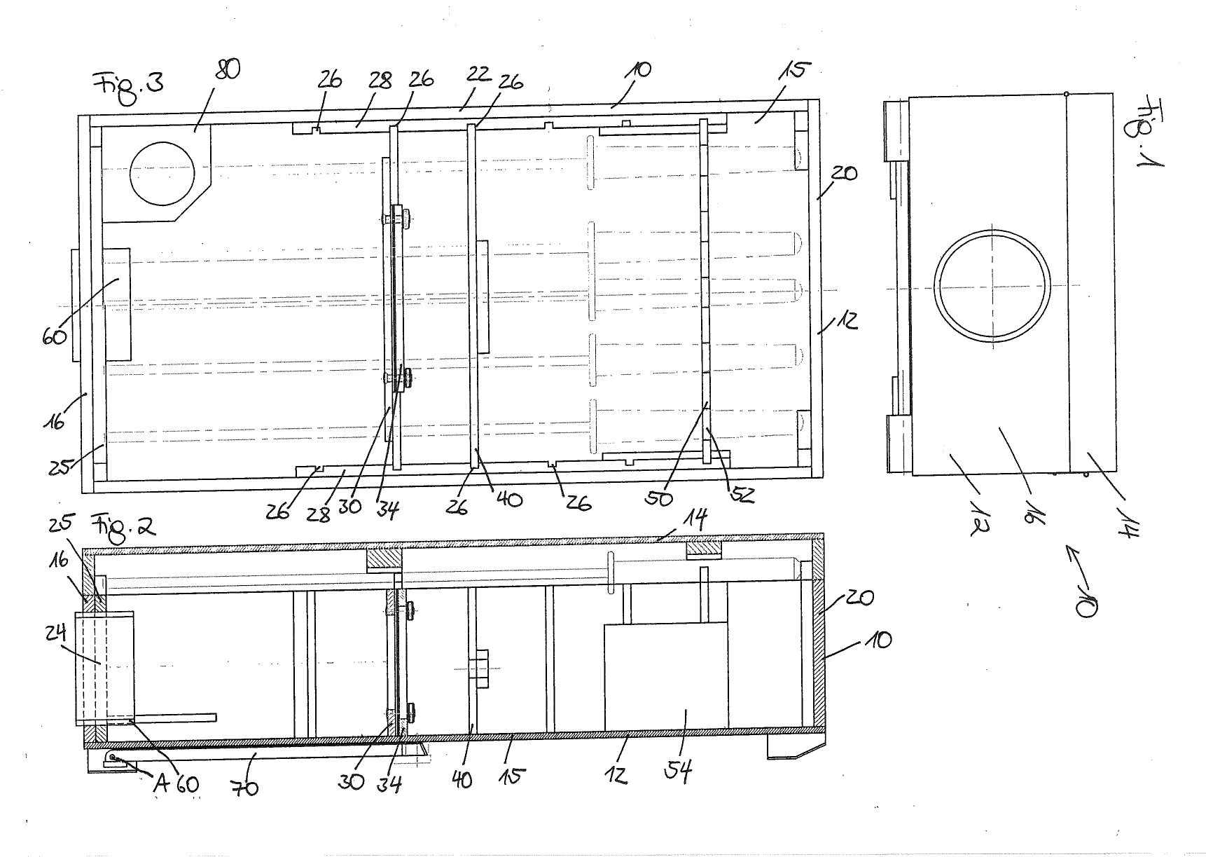

Different views of a housing 10 of a simulator for simulation of surgical procedures, particularly in cardiac and thoracic surgery, are shown in FIGS. 1 to 3. The housing 10 has a bottom part 12 and a lid part 14. The lid part 14 can be completely removable from the bottom part 12, for example, or can be connected with the bottom part 12 by way of hinges.

The bottom part 12 has a wall 15 that forms the bottom wall and four walls 16, 18, 20, 22. The housing 10 simulates the chest of a patient. The housing 10 can be made, for example, of wood or plastic or metal, for example aluminum.

The wall 16, which forms the front side of the bottom part 12, has a passage opening 24, through which access into the housing 10 is made possible. The passage opening 24 particularly simulates the operation access to the patient.

Surgical instruments, particularly those required for the surgical procedure, can be introduced into the housing 10 with their distal end, through the passage opening 24, while the proximal ends remain outside the housing 10, in order to be able to simulate a minimally invasive surgical procedure.

The wall 16 can be reinforced by a reinforcement plate 25, which is particularly attached on the inside of the wall 16, for example glued on. The reinforcement plate 25 has an opening 25a that aligns with the passage opening 24.

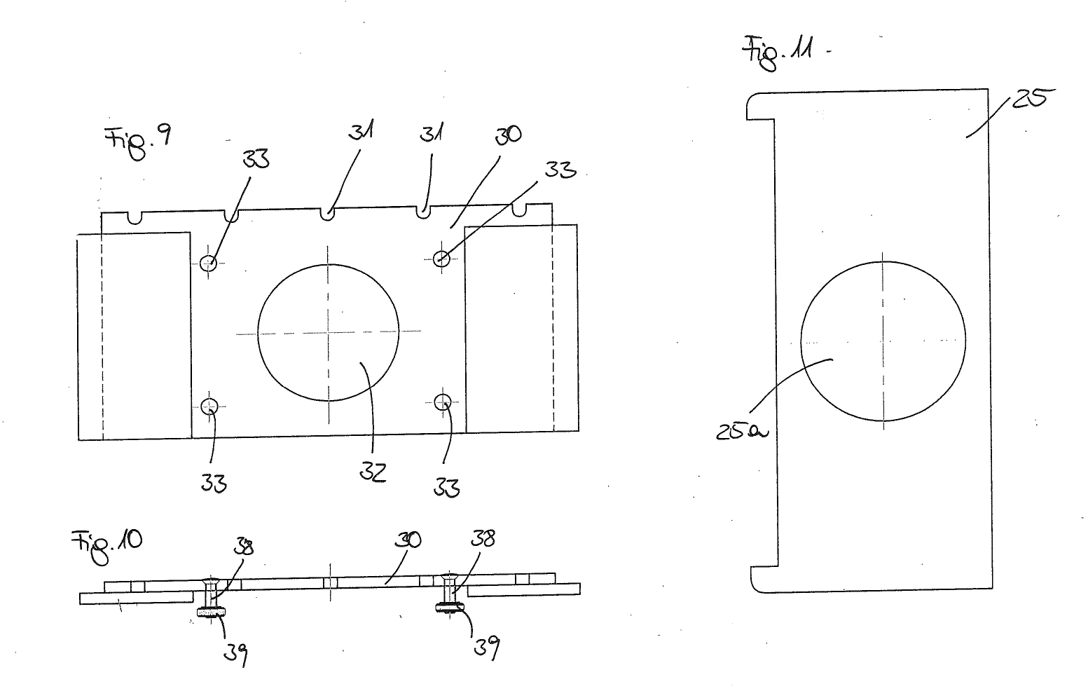

A hollow tube 60 can be inserted into the passage opening 24, which tube is produced from Plexiglas, for example (cf. FIGS. 7 and 8). The simulator preferably comprises hollow tubes 60 in different lengths, in order to allow different degrees of difficulty in the simulation of surgical procedures.

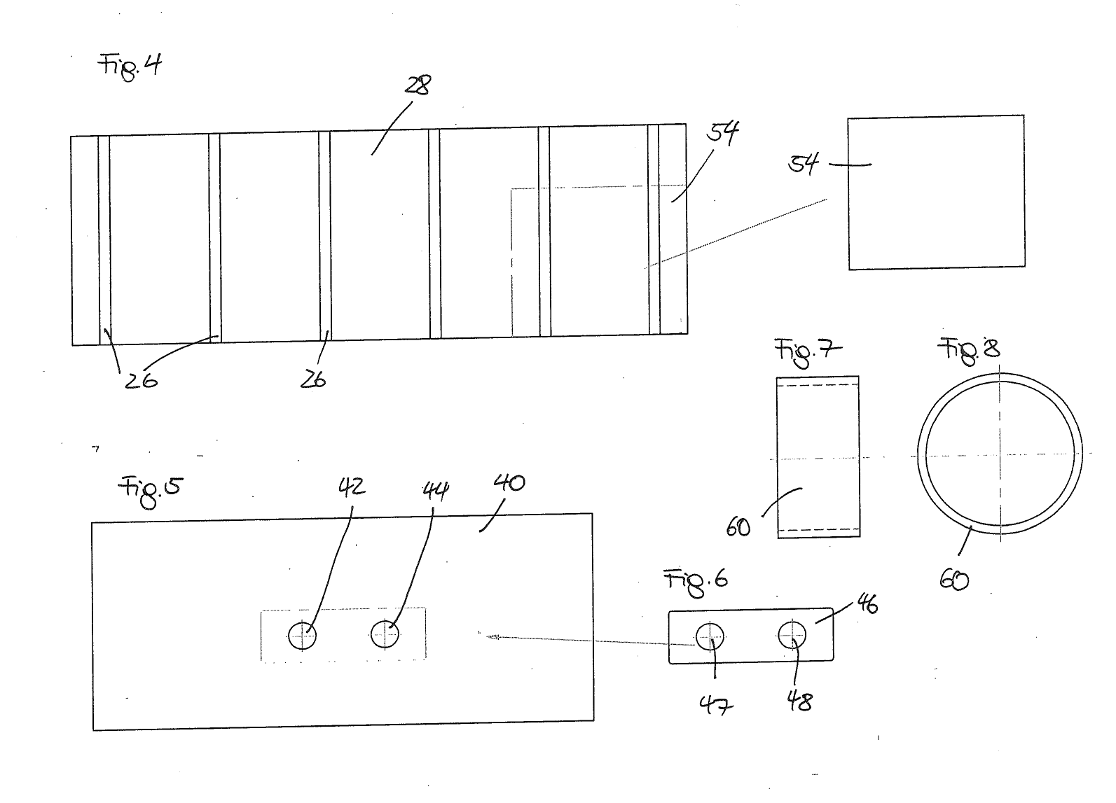

At least one, preferably multiple variable walls 30, 40, 50 can be inserted into the bottom part 12 of the housing 10. For this purpose, multiple grooves 26 that run parallel to one another are disposed on the opposite walls 18, 22. The grooves 26 can either be disposed directly in the walls 18, 22. Alternatively, a grooved plate 28 (cf. FIG. 4) is disposed on the walls 18, 20, in each instance, which plate has multiple grooves 26, in each instance. The grooved plates 28 can be glued onto the walls 18, 22 or be attached in some other manner The variable walls 30, 40, 50 are inserted into the grooves 26 in such a manner that they are disposed essentially parallel to the wall 16 that comprises the passage opening 24.

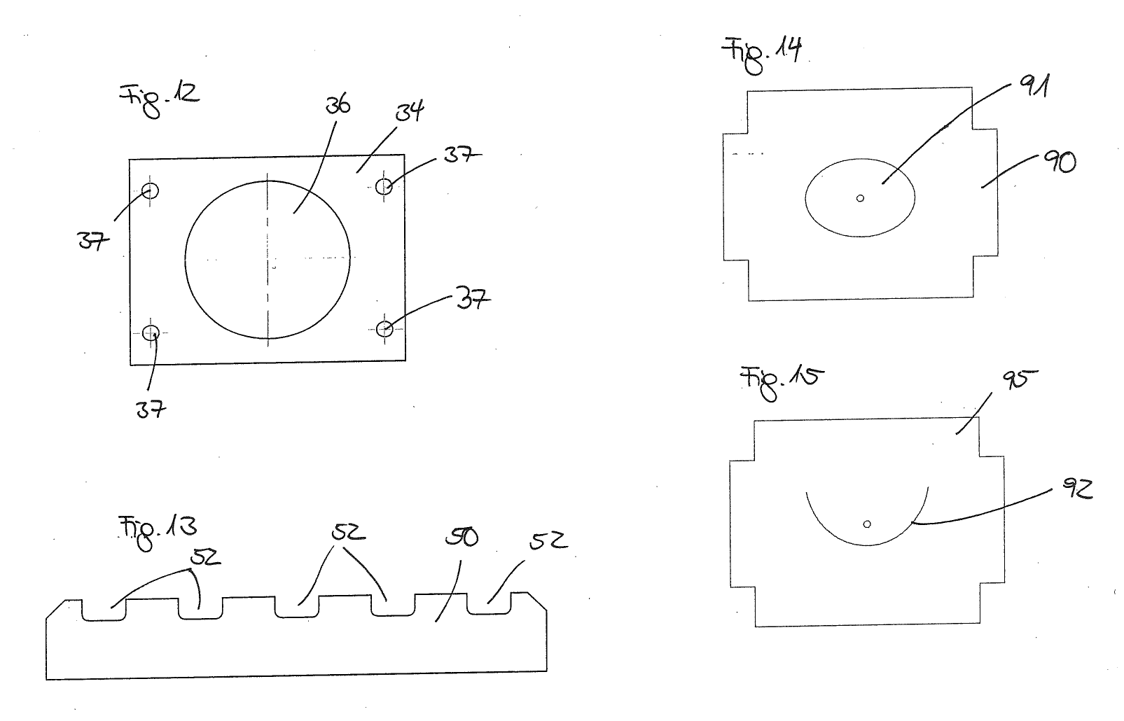

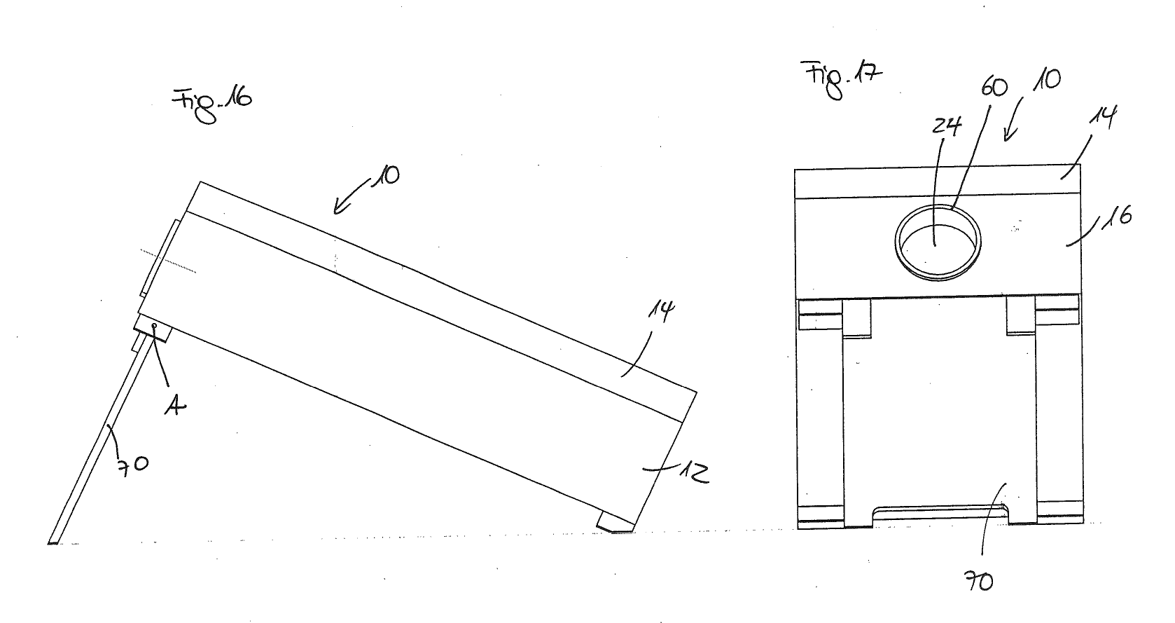

The variable wall 30 (cf. FIGS. 9 and 10) has an opening 32 that is preferably oriented to align with the passage opening 24. A holding apparatus and/or attachment apparatus is provided on the variable wall 30, which apparatus can particularly be configured as a plate 34 (cf. FIG. 12) that has an opening that has approximately the same diameter as the opening 32 of the variable wall 30. The variable wall 30 has multiple attachment openings 33, while the plate 34 has multiple attachment openings 37. The plate 34 can be attached to the variable wall 30 using screws 38, if the plate 34 is laid onto the variable wall 30 in such a manner that the opening 36 aligns with the opening 32, the attachment openings 37 align with the attachment openings 33, and the screws 38 are passed through the attachment openings 33, 37 and attached by means of a nut 39. It is also possible, for example, to fix the screws in place in the attachment openings 33 of the variable wall 30, for example to glue them in place, and to screw nuts 39 onto the screws 38 after the plate 34 has been set onto the variable wall 30 (cf. FIG. 10).

The variable wall 40 (cf. FIG. 5) has two openings 42, 44 that particularly have a smaller diameter than the opening 32 of the variable wall 30 and are disposed laterally offset with regard to the axis between the center point of the opening 32 of the variable wall 30 and the center point of the passage opening 24. For reinforcement of the openings 42, 44, a reinforcement plate 46 (cf. FIG. 6) is disposed on the variable wall 40, which plate also has two openings 47, 48 that align with the openings 42, 44 when the reinforcement plate 42 is put in place.

The variable wall 50 (cf. FIG. 13) has multiple recesses 52 on its upper edge, into which different surgical instruments can be laid for transport in the housing 10. The variable wall 50 preferably has a lesser height than the variable walls 30, 40 and is introduced into the grooves 26 not all the way to the bottom wall 15, but rather lies on support elements 54 glued onto the walls 18, 22 or the grooved plates 28 (cf. FIGS. 2 and 4). In order to be able to fix the instruments in place reliably, the variable wall 30 also has recesses 31 on its upper edge.

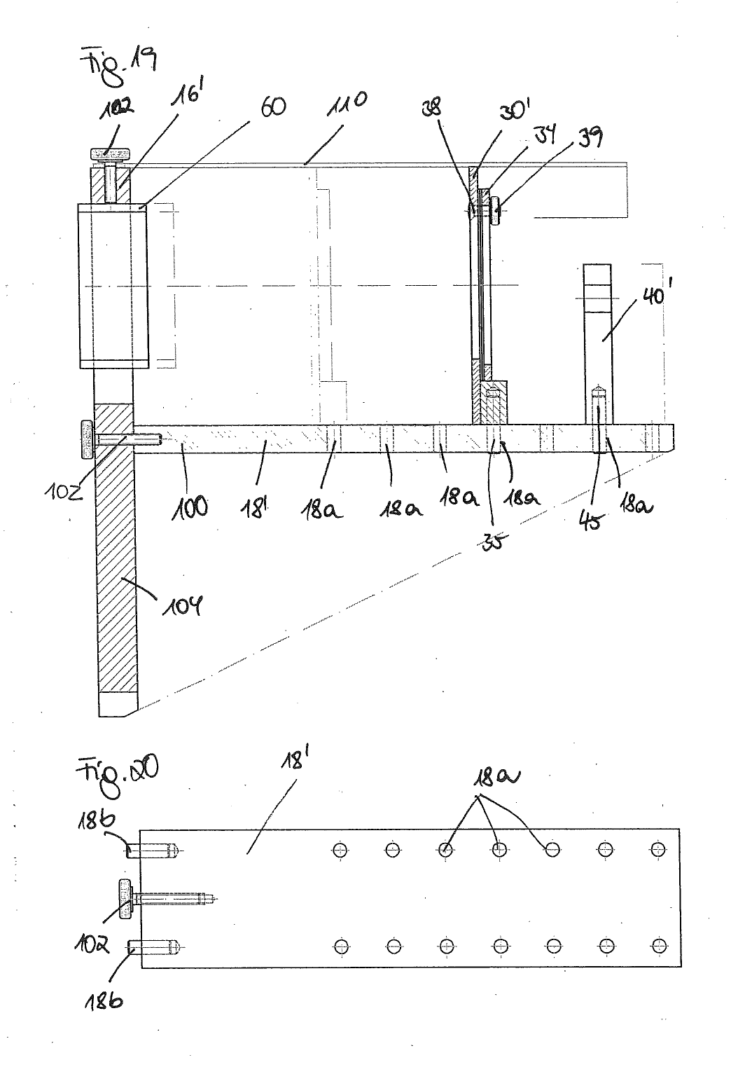

In order to facilitate access into the housing 10, the housing 10 has a setup flap 70 on its underside (cf. also FIGS. 18 and 18a), which is disposed on the housing 10 so as to pivot about an axis A. In FIG. 2, the setup flap 70 is shown in the folded-in position; in FIGS. 16 and 17, the setup flap 70 is pivoted out. As a result, the housing 10 can be inclined relative to a support surface, for example a table surface, by an angle of 25° or 30°, for example, in order to facilitate access through the passage opening 24. If the setup flap 70 is pivoted in, it can preferably be locked in this position, in order to prevent it from accidentally pivoting out.

For simulation of a surgical procedure, particularly in cardiac or thoracic surgery, the housing 10 can be used as follows.

The hollow tube 60 having the desired length is inserted into the passage opening 24. The greater the length of the hollow tube 60, the more restricted the movement possibility for the surgical instruments inserted into the interior of the housing 10 through the hollow tube 60.

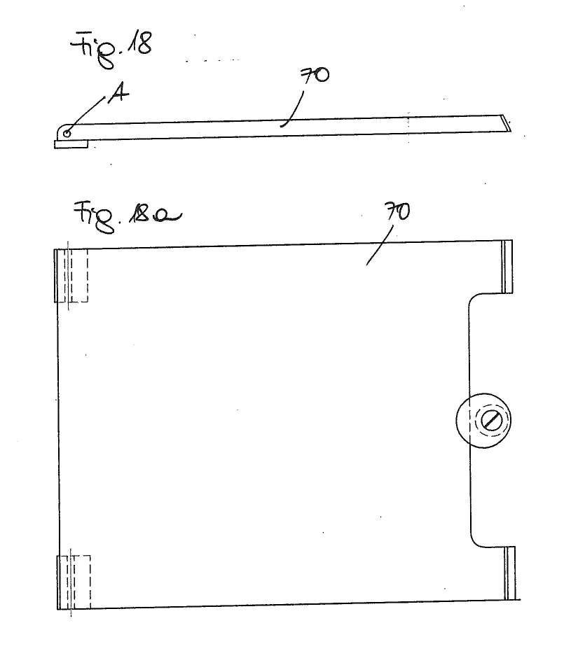

The variable wall 30 is equipped with artificial body parts as follows. The simulator 10 preferably comprises two templates 90, 95 (cf. FIGS. 14 and 15), which can be used to produce two artificial body parts, for example parts simulating the mitral valve cusps, from woven microfiber fabric, for example. Alternatively, the simulator 10 can also comprise artificial body parts that have already been produced in accordance with the templates 90, 95.

The one artificial body part can be produced from a piece of cloth, for example a microfiber cloth, as an element having a centric opening 91, using the template 90, while the other artificial body part can be produced from a piece of cloth, for example a microfiber cloth, as an element having an approximately arc-shaped cross-section 92, using the template 95, in order to represent an approximately semicircular flap that simulates a heart valve. The two artificial body parts according to templates 90, 95 are attached to the variable wall 30, using the plate 34, in such a manner that they are clamped in place between the variable wall 30 and the plate 34, in such a manner that the opening 91 of the body part according to the template 90 comes to lie in front of the opening 32, and the semicircular element of the body part according to the template 95 comes to lie in front of the opening 91 of the body part 90. The variable wall 30 is inserted into the bottom part 12 at a desired distance from the passage opening 24.

Artificial body parts that simulate heart muscle parts are inserted into the two openings 42, 44 of the variable wall 40. For this purpose, a piece of foam rubber in a cylindrical shape, or a foam rubber element in a rectangular shape, which has been rolled up into a cylinder, is inserted through the openings 42, 44. The variable wall 40 is disposed in the bottom part 12 in such a manner that it is disposed behind the variable wall 30, from the viewing direction of the passage opening 24.

In a simple simulation, the lid part 14 can remain open and a surgical procedure, for example suturing on an artificial heart valve, can be carried out with a direct view of the instruments and the artificial body parts in the manner of the templates 90, 95.

In a more difficult simulation, the lid part 14 can be closed and the surgical procedure can be carried out using further surgical instruments for lighting and imaging, for example an endoscope. Alternatively, a light source and a camera can be disposed on a holder 80 in the housing, and these are used to transmit what is happening in the interior of the housing 10 to a screen. In order to allow power supply and image transmission by means of cables, the housing can have a passage opening in one of the walls 16, 18, 20, 22, in order to be able to conduct the cables from the camera and/or the light source to the outside.

All of the components required for the simulation can be stowed in the housing 10. For stowing and transport, also of the surgical instruments required for the simulation, the variable wall 50 is inserted into one of the grooves 26 that preferably has the greatest distance from the passage opening 24. In addition, the variable wall 30, for example, also has recesses 31 on its top edge, so that the surgical instruments can be laid into the recesses 31, 52 parallel to the walls 22, 18, and can be held securely during transport, as indicated with a dot-dash line in FIG. 3.

A second exemplary embodiment of a simulator is shown in FIGS. 19 to 25. The same reference numbers refer to the same parts as in the exemplary embodiment shown in FIGS. 1 to 18.

The simulator for simulation of surgical procedures, particularly in cardiac or thoracic surgery, has a frame 100 that has a first wall 16′, which forms the front side in the present exemplary embodiment, and a second wall 18′, which forms the bottom wall in the present exemplary embodiment.

The first wall 18′ can be attached to the wall 16′ by way of a screw connection by means of a screw 102 and/or by way of a journal connection by means of two journals 18b, which can be inserted into corresponding recesses 16b in the wall 16′.

The passage opening 25 is disposed in the first wall 16′. The hollow tubes 60 can be inserted into the passage opening 25 in the manner described for the first exemplary embodiment.

In this connection, the wall 18′ is preferably disposed at a distance from a side edge of the wall 16′ and particularly at a right angle to the wall 16′, wherein the passage opening 25 is disposed in the wall 16′ on one side of the wall 18′, and the part of the wall 16′ disposed on the other side of the wall 18′ forms a setup foot 104 for the simulator.

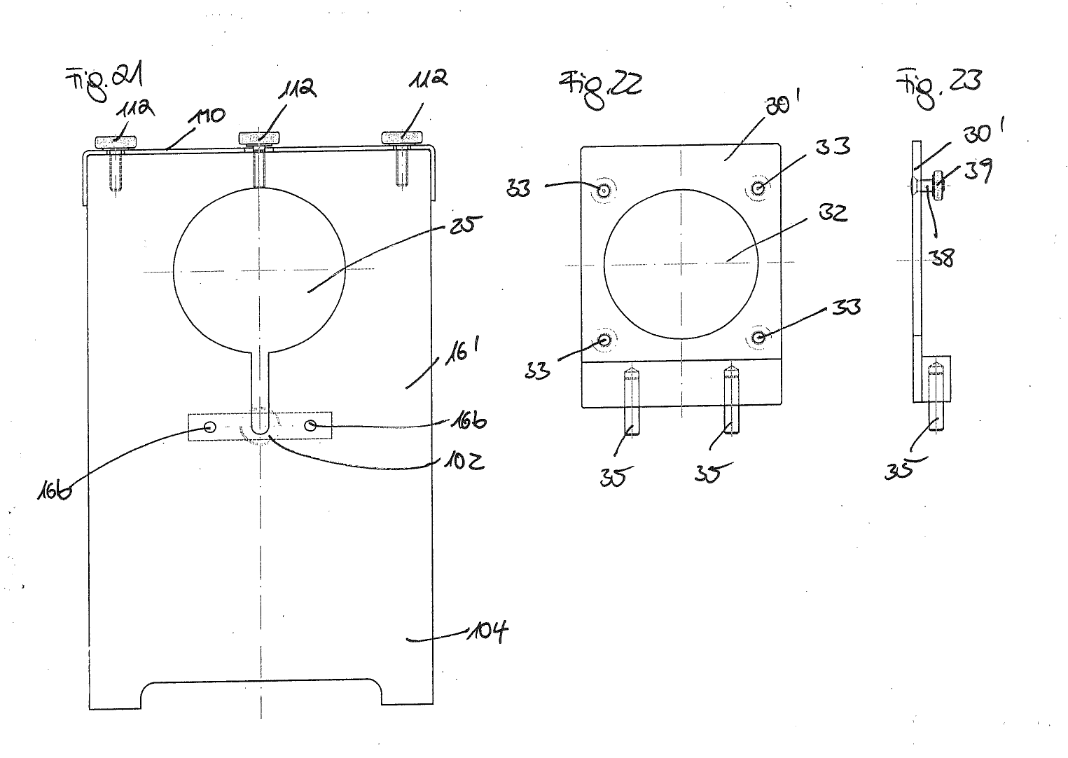

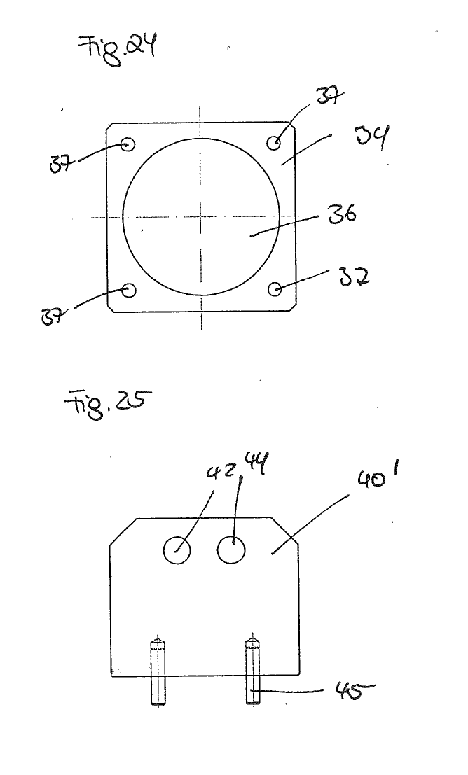

In FIGS. 22 and 23, a variable wall 30′, which is structured in comparable manner to the variable wall 30 of the first exemplary embodiment, is shown. Instead of introducing the variable wall 30′ into a groove, the variable wall 30′ has two journals 35, with which it can be set into two corresponding recesses 18a of the wall 18′. FIG. 24 shows the plate 34, which forms the holding apparatus and/or attachment apparatus of the variable wall 30′ and can be attached to the variable wall 30′ analogous to the plate 34 shown in FIG. 12.

FIG. 25 shows a variable wall 40′ that is comparable to the variable wall 40 of the first exemplary embodiment. This wall has two openings 42, 44. A reinforcement plate is optional. The variable wall 40′ can be inserted into two recesses 18a of the wall 18′ by means of two journals 45. In particular, the distance of the variable wall 40′ from the wall 16′ is greater than the distance of the variable wall 30′ from the wall 16′, in order to perform the simulation.

The simulator according to the second exemplary embodiment can be equipped, in analogous manner, with body parts according to the templates 90, 95 for simulation of the heart valves or corresponding templates 90, 95, and, if necessary, further additional body parts for simulation of heart muscle parts, with hollow tubes 60 and/or a plastic cuff, with a camera and/or a light source, and, if necessary, with corresponding surgical instruments.

A simulation can take place in the same manner as with the simulator according to the first exemplary embodiment. In order to prevent a direct view of the simulated operation being performed, the frame 100 can be covered with a cloth. Alternatively, a cover plate 110 can be attached to the wall 16′ by means of one or more screws 112 (cf. FIGS. 19 and 21).

### REFERENCE SYMBOL LIST

10 housing
12 bottom part
14 lid part
15 bottom wall
16 wall
16′ wall
16b recess
18 wall
18′ wall
18a recess
18b journal
20 wall
22 wall
24 passage opening
25 reinforcement plate
25a opening
26 groove
28 grooved plate
30 variable wall
30′ variable wall
31 recess
32 opening
33 attachment opening
34 plate
35 journal
36 opening
37 attachment opening
38 screw
39 nut
40 variable wall
40′ variable wall
42 opening
44 opening
45 journal
46 reinforcement plate
47 opening
48 opening
50 variable wall
52 recess
54 support element
60 hollow tube
70 setup flap
80 holder
90 template for an artificial body part
91 opening
92 cross-section
93 template for an artificial body part
100 frame
102 screw
104 setup foot
A axis

What is claimed:

1. A simulator for surgical procedures, comprising:
a frame having a first wall and a second wall;
wherein a passage opening is disposed in the first wall;
wherein a variable wall can be inserted on the second wall in at least two different positions; and
wherein the variable wall has an opening.

2. The simulator according to claim 1, wherein at least two variable walls can be disposed on the second wall.

3. The simulator according to claim 1, wherein the frame is part of a housing comprised of a bottom part and a lid part; and
wherein the bottom part has the first wall, the second wall, and three further walls.

4. The simulator according to claim 1, wherein the variable wall can be inserted into grooves or recesses of the second wall.

5. The simulator according to claim 1, wherein a holding apparatus for an artificial body part is disposed on the variable wall.

6. The simulator according to claim 1, wherein the holding apparatus is a plate, which has an opening and can be attached to the variable wall.

7. The simulator according to claim 1, wherein the variable wall provides at least two openings.

8. The simulator according to claim 1, wherein a setup element is disposed on the frame or on the housing.

9. The simulator according to claim 1, further comprising a camera and a light source.

10. The simulator according to claim 1, further comprising a hollow tube for insertion into the passage opening.

11. The simulator according to claim 1, further comprising a plastic cuff for insertion into the passage opening.

12. The simulator according to claim 1, further comprising an artificial body for insertion into the opening of the variable wall.

13. The simulator according to claim 1, wherein an edge of the variable wall has recesses for placement of surgical instruments.

14. The simulator according to claim 1, wherein the frame and the variable walls are made from wood, plastic, metal or a combination thereof.

15. The simulator according to claim 1, wherein the setup element is selected from the group consisting of a setup flap, a setup bracket and a setup foot.

16. The simulator according to claim 1, further comprising a template for production of an artificial body part for insertion into the opening of the variable wall.

17. The simulator according to claim 1, further comprising multiple hollow tubes of different lengths for insertion into the passage opening.
